(19) United States
(12) Patent Application Publication
(10) Pub. No.: US 2005/0147831 A1
(43) Pub. Date: Jul. 7, 2005

(54) Reflective sheet

(75) Inventor: Chang Yen Hsieh, Hsin Chu Hsien (TW)

Correspondence Address: Chang Yen Hsieh;Xinyi District, 9F., No. 37, Dongsing Road, Taipei City, 110, TW

(73) Assignee: Jan-Ann Co., Ltd.

(21) Appl. No.: 11/009,354

(22) Filed: Dec. 13, 2004

(30) Foreign Application Priority Data
Dec. 15, 2003 (TW) 093117945

(51) Int. Cl. B32B 9/00

(52) U.S. Cl. 428/428

(57) ABSTRACT

A reflective sheet includes at least a substrate, a metal reflection layer formed on a top of the substrate, and a diffusion layer formed on a top of the metal diffusion layer to provide an increased reflecting efficiency and enable more even diffusion of light.

### FIELD OF THE INVENTION

The present invention relates to a reflective sheet, and more particularly to a reflective sheet that provides increased reflecting efficiency and enables more even diffusion of light.

### BACKGROUND OF THE INVENTION

The term “flat panel display” is one of many terms that draw most people's attention in recent years. Having occupied the market for several decades, the traditional cathode ray tube display finally encounters a full challenge from the display technology of new generation. The liquid crystal display (LCD), the plasma display panel (PDP), and the organic electric excitation light emitting display (OLED), which have the advantages of compact volume, low heat production, low power consumption, and almost free of radiation hazards, have largely occupied the consumptive information equipment market. Among others, the thin-film transistor liquid crystal display (TFT-LCD) technology is particularly rapidly developed to announce the advent of the era of high-quality display through actual and large-scale investment and mass production thereof. People may find the liquid crystal displays have been widely employed in many apparatus from the small-size color mobile phones to the big-size TV sets, and brought the most important revolution in the applied science in the early twenty-one century.

The liquid crystal display has a main structure that could be roughly divided into two major parts, namely, a front panel and a backlight module. To manufacture the front panel, elements such as ITO conducting glass, liquid crystal, alignment material, color filter, polarization screen, driving IC, etc. are involved. The backlight module includes light tube(s), light-conducting sheet, and various kinds of optical films. An overall performance of the liquid crystal display is subject to the interaction of all sections in the backlight module with one another. Particularly, the optical films play a very important role in the brightness, the evenness, the contrast, and the view angle of the display. In response to the increasingly expanded size and the increasingly enhanced resolution of liquid crystal panel, more light tubes or higher tube current is used to increase the volume of light incident. On the other hand, attempts have been made to increase the aperture ratio on the panel in order to reduce the loss of light source, and wide-angle liquid crystal alignment manufacturing processes, such as Multi-domain Vertical Alignment (MVA), Advanced Super V (ASV), In-plane Switching (IPS), etc., have been positively introduced, enabling the liquid crystal display to present even better viewing angle and colors. What is a pity is the increase of panel brightness simply by increasing the number of light tubes not only results in accumulation of excessive heat in the mechanism to adversely affect the usable life and quality of other sections thereof, but also consumes too much power to satisfy the requirement of wireless use of many battery-powered information products. Meanwhile, the use of advanced liquid crystal panel would involve in the cost factors, such as product orientation, the good yield of products, etc., and the technical factors, such as licensing of patents, design of electrodes, etc. Therefore, up to date, the most economical and simplest solution to achieve the design target of flat panel display is to use various kinds of optical films in the backlight module to increase the overall brightness and most effectively utilize the light source without changing any cell design or consuming additional energy. As a result, there has been developed a reflective sheet that is able to increase the overall brightness of the display, so that the light source is most effectively utilized without the need of changing any cell design or consuming additional energy.

The reflective sheet provides two functions in the backlight module, namely, effectively reflecting light emitted from the light source to a light-conducting sheet with a performance thereof depending on a reflectivity of mirror reflection; and diffusing and reflecting light leaked from the light-conducting sheet back to the light-conducting sheet, so that light beams parallelly moves in the light-conducting sheet are changed to a moving direction perpendicular to the light-conducting sheet and then escape from the latter. A common purpose of these two functions is to hopefully reflect the light incident at a high reflecting efficiency so as to increase an overall brightness of the display. However, the conventional reflective sheet has the disadvantages of inferior reflecting effect, uneven diffusion of reflected light, etc. Please refer to FIG. 1 that schematically shows the structure of a conventional backlight module 1 and a reflective sheet 11 thereof.

As shown, the conventional backlight module 1 is composed of a reflective sheet 11, a cold cathode tube 12, a first diffusion sheet 13, and two second diffusion sheets 14. Please refer to FIG. 2 that is a sectional view of the conventional reflective sheet 11 of FIG. 1. The reflective sheet 11 is mainly made of a polyethylene terephthalate (PET) material with one surface thereof coated with a diffusion layer 111 containing titanium dioxide. When the titanium dioxide is dry and set, it forms a white frosted surface that not only enables light to diffuse more evenly, but also provides a certain reflecting effect, and is therefore widely employed. However, the diffusion layer 111 diffusing the light also results in a lowered reflectivity of the reflective sheet 11 to necessitate more and stronger light sources for the backlight module and accordingly, increased power consumption thereof. Since general apparatus with a small-size flat panel display, such as mobile phones and personal digital assistants, have a limited volume that could not accommodate more light sources, the backlight module with more light sources is usually employed in a relatively big-sized flat panel display, such as a liquid crystal display (LCD) for computers.

FIG. 3 is a sectional view of another conventional reflective sheet 11′. As shown, the reflective sheet 11′ is mainly made of a mixture of PET and titanium dioxide. With bubbles 111′ of titanium dioxide inside the reflective sheet 11′, light incident is scattered once again and more evenly diffused to achieve a certain reflecting effect at the same time. This type of reflective sheet 11′ is therefore widely employed. However, the bubbles 111′ scattering the light also result in a lowered reflectivity of the reflective sheet 11′ to necessitate more and stronger light sources for the backlight module and accordingly increased power consumption thereof. Since general apparatus with a small-size flat panel display, such as mobile phones and personal digital assistants, have a limited volume that could not accommodate more light sources, the backlight module with more light sources is usually employed in a relatively big-sized flat panel display, such as a liquid crystal display (LCD) for computers.

FIG. 4 is a sectional view of a further conventional reflective sheet 11. As shown, the reflective sheet 11 in FIG. 4 is mainly made of a PET material with one surface thereof coated with a metal reflection layer 112 containing silver or aluminum. The metal reflection layer 112 reflects light to largely increase the reflectivity of the reflective sheet 11. However, the reflected light would result in uneven distribution of light sources. Moreover, any fold and defect formed during assembling or manufacturing the reflective sheet, or any deformation of the reflective sheet due to high temperature would cause irregularly reflected light or even non-reflection of light to result in poor picture on the display. When the reflective sheet 11 is used in a big-size flat panel display, such as the liquid crystal display for a computer, it is more easily subject to folds, defects, and high temperature caused deformation during assembling or manufacturing thereof to form particularly distinct areas of poor picture on the display. The reflective sheet 11 of FIG. 4 is therefore not suitable for use in the big-size flat panel display. To minimize the poor picture, the reflective sheet 11 of FIG. 4 is currently usually employed in small-size flat panel display for mobile phone and personal digital assistant.

It is therefore tried by the inventor to develop an improved reflective sheet that has increased reflecting efficiency and enables light to be more evenly diffused.

### SUMMARY OF THE INVENTION

A primary object of the present invention is to provide a reflective sheet that provides increased reflecting efficiency.

Another object of the present invention is to provide a reflective sheet that enables more even diffusion of light.

To achieve the above and other objects, the reflective sheet of the present invention includes at least a substrate, a metal diffusion layer formed on a top of the substrate, and a diffusion layer formed on a top of the metal diffusion layer.

With the metal diffusion layer and the diffusion layer, the reflective sheet of the present invention provides increased reflecting efficiency and more even diffusion of light.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the structure of a conventional backlight module and a reflective sheet thereof;

FIG. 2 is a fragmentary and enlarged sectional view of the conventional reflective sheet of FIG. 1;

FIG. 3 is a fragmentary and enlarged sectional view of another conventional reflective sheet;

FIG. 4 is a fragmentary and enlarged sectional view of a further conventional reflective sheet;

FIG. 5 shows the positional relation of a reflective sheet of the present invention to a backlight module; and

FIG. 6 is an enlarged sectional view of the reflective sheet of the present invention.

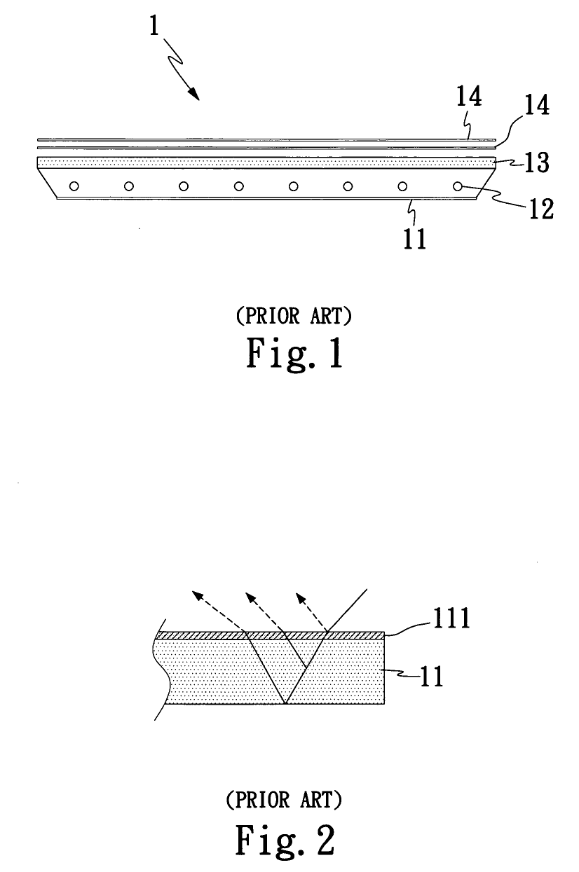

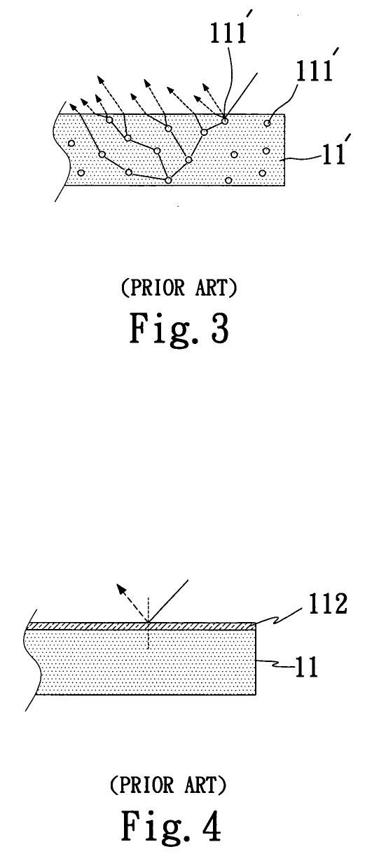

### DETAILED DESCRIPTION OF THE PREFERRED EMBODIMENTS

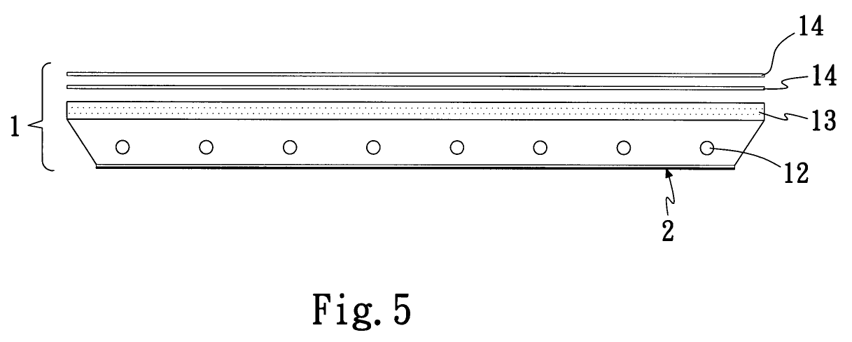

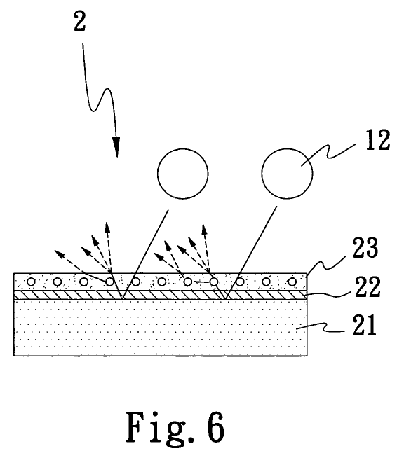

Please refer to FIG. 5 that shows the positional relation of a reflective sheet 2 of the present invention to a backlight module 1; and to FIG. 6 that is an enlarged sectional view of the reflective sheet 2 of the present invention.

As shown, the backlight module 1 is composed of a cold cathode tube 12, a first diffusing sheet 13, and two second diffusing sheets 14. The reflective sheet 2 of the present invention is disposed below the cold cathode tube 12.

As can be clearly seen from FIG. 6, the reflective sheet 2 includes at least a substrate 21, which is mainly made of a PET material; a metal reflection layer 22, which is mainly an aluminum or a silver material formed on a top of the substrate 21 by means of sputter coating or vacuum sputtering to provide an increased reflectivity of the substrate 21; and a diffusion layer 23, which is mainly a titanium dioxide or a silicon dioxide material applied on a top of the metal reflection layer 22.

With the above arrangements, the reflective sheet of the present invention provides the following advantages:
1. Good reflectivity:
   The metal reflection layer formed on the reflective sheet by means of sputter coating or vacuum sputtering provides high reflectivity, which enables the reflective sheet of the present invention to have good reflecting efficiency.
2. Enabling light to diffuse more evenly:
   The diffusion layer applied on the metal reflection layer enables light to diffuse more evenly, so that light reflected from the reflective sheet of the present invention also diffuse more evenly.
3. Adaptation to flat panel displays of various sizes:
   With the metal reflection layer, the reflective sheet of the present invention provides good reflecting efficiency and therefore does not require any additional light source, making it advantageously suitable for using in small-size flat panel displays for, for example, mobile phones and personal digital assistants (PDAs). On the other hand, with the diffusion layer, the reflective sheet of the present invention is able to diffuse the reflected light in a more evenly manner to reduce the area with poor picture, and is therefore advantageously suitable for use in large-size flat panel displays for, for example, liquid crystal displays of computers. Thus, the reflective sheet of the present invention is suitable for flat panel displays of various sizes.

1. A reflective sheet, comprising:
a substrate;
a metal reflection layer being formed on a top of said substrate; and
a diffusion layer being formed on a top of said metal reflection layer.

2. The reflective sheet as claimed in claim 1, wherein said substrate is mainly made of polyethylene terephthalate (PET).

3. The reflective sheet as claimed in claim 1, wherein said metal reflection layer is made of aluminum.

4. The reflective sheet as claimed in claim 1, wherein said metal reflection layer is made of silver.

5. The reflective sheet as claimed in claim 1, wherein said metal reflection layer is formed on the top of said substrate by means of sputter coating.

6. The reflective sheet as claimed in claim 1, wherein said metal reflection layer is formed on the top of said substrate by means of vacuum sputtering.

7. The reflective sheet as claimed in claim 1, wherein said diffusion layer is made of titanium dioxide.

8. The reflective sheet as claimed in claim 1, wherein said diffusion layer is made of silicon dioxide.
